(19) United States
(12) Patent Application Publication
(10) Pub. No.: US 2019/0025496 A1
(43) Pub. Date: Jan. 24, 2019

(54) PANEL LIGHT AND MANUFACTURING METHOD THEREOF

(71) Applicant: GE Lighting Solutions, LLC, East Cleveland, OH (US)

(72) Inventors: Shouyong Zhou, Shanghai (CN); Honglei Gao, Shanghai (CN); Cuijuan Zhou, Shanghai (CN); Hui Li, Shanghai (CN); JunQi Ren, Shanghai (CN); Qiang Li, Shanghai (CN)

(21) Appl. No.: 16/000,466

(22) Filed: Jun. 5, 2018

(30) Foreign Application Priority Data
Jul. 21, 2017 (CN) 201710599829.1

(51) Int. Cl. F21V 8/00; G02B 6/42

(52) U.S. Cl. CPC G02B 6/0068; G02B 6/0055; G02B 6/428; G02B 6/0083; G02B 6/0051

(57) ABSTRACT

The present invention discloses a panel light, which includes a front bezel having multiple frames, at least one circuit board, a light guide, and light sources. The light sources are mounted on the at least one circuit board, the at least one circuit board is fixed on at least one of the multiple frames, and the light guide is disposed inside the front bezel, where a distance between a first light source and the light guide includes a first distance and a distance between a second light source and the light guide includes a second distance, and the first distance is less than the second distance. The present invention further discloses a method for manufacturing a panel light. The panel light of the present invention not only can protect the light sources and light guide against damage, but also can relatively reduce distances between the light sources and the light guide, thus improving light utilization.

### TECHNICAL FIELD

The present invention relates to the field of illumination technology, and in particular, to a panel light and a manufacturing method thereof.

### BACKGROUND

In the technical field of illumination lamps, panel lights are widely applied. Through a light guide with high light transmittance, light emitted by a light source is turned into uniform planar light. Light loss occurs in part of the light because there is a gap between the light source and the light guide. In order to reduce the light loss, a gap between a light source and a light guide of an existing panel light is set to be rather small, so that light emitted by the light source can effectively pass through the light guide. However, the light guide easily expands with heat and contracts with cold, and therefore it easily contacts the light source directly, resulting in damage to the light source. To protect the light source, an anti-collision block is usually mounted near the light source as a protecting device. The anti-collision block is higher than the light source to protect the light source. However, because the material of the anti-collision block is hard and does not easily deform, when the light guide expands and contacts the anti-collision block to cause a collision, the light guide is firmly pressed to deform or even break.

However, in order to ensure that neither of the light source and light guide is damaged, a relatively large gap needs to be set between the light source and the light guide, which, however, results in reduced light flux and low light utilization.

Therefore, in view of this, the problem how to improve the light flux and light utilization on the premise of ensuring that neither of the light source and light guide is damaged is in urgent need to be solved.

### SUMMARY OF THE INVENTION

One aspect of the present invention provides a panel light. The panel light includes a front bezel having multiple frames, at least one circuit board, a light guide, and light sources. The light sources are mounted on the at least one circuit board, the at least one circuit board is fixed on at least one of the multiple frames, and the light guide is disposed inside the front bezel, where a distance between a first light source and the light guide includes a first distance and a distance between a second light source and the light guide includes a second distance, and the first distance is less than the second distance.

Another aspect of the present invention provides a method for manufacturing a panel light. The method for manufacturing a panel light includes: manufacturing a front bezel, including: making multiple quadrate frames, cutting the multiple quadrate frames into multiple trapezoidal frames by at least two different cutting angles, and connecting adjacent hypotenuses of the multiple trapezoidal frames so as to form the front bezel and form at least one convex frame towards a light guide to be mounted; mounting light sources on at least one circuit board; mounting the at least one circuit board on the at least one convex frame; and mounting the light guide inside the front bezel.

### BRIEF DESCRIPTION OF THE DRAWINGS

These and other features, aspects, and advantages of the present invention can be better understood when the following detailed description is read with reference to the accompanying drawings. In the accompanying drawings, identical numerals are used to refer to identical parts throughout the accompanying drawings, wherein:

FIG. 1 is an overall diagram of a panel light according to a specific embodiment of the present invention;

FIG. 2 is an exploded structural diagram of the panel light shown in FIG. 1;

FIG. 3 is a partial sectional diagram of the panel light shown in FIG. 1;

FIG. 4A is a schematic structural diagram of a front bezel of the panel light shown in FIG. 1 before connection;

FIG. 4B is a schematic structural diagram of the front bezel shown in FIG. 4A after connection;

FIG. 5 is a schematic partial enlarged diagram of part A of the panel light shown in FIG. 1;

FIG. 6 is a schematic partial diagram of a panel light according to another specific embodiment of the present invention; and

FIG. 7 is a flowchart of a method for manufacturing a panel light according to a specific embodiment of the present invention.

### DETAILED DESCRIPTION

In order to help persons skilled in the art understand the subject matter claimed in the present invention, specific embodiments of the present invention will be described in detail below with reference to the accompanying drawings. In the following detailed description of these specific embodiments, the present specification does not describe in detail any of the known functions or configurations, to avoid unnecessary details that may affect the disclosure of the present invention.

Unless otherwise defined, the technical and scientific terms used in the claims and the specification are as they are usually understood by those skilled in the art to which the present invention pertains. The “first”, “second” and similar words used in the patent specification and claims of the present invention do not denote any order, quantity or importance, but are merely intended to distinguish between different constituents. The terms “one”, “a” and similar words are not meant to be limiting, but rather denote the presence of at least one. “Comprising”, “consisting of” and similar words mean that the elements or articles appearing before “comprising” or “consisting of” include the elements or articles and their equivalent elements appearing behind “comprising” or “consisting of”, not excluding any other elements or articles. “Connected”, “coupled” and similar words are not restricted to physical or mechanical connections, but may also include electrical connections, whether direct or indirect. In addition, terms indicating specific positions, such as “top”, “bottom”, “left”, and “right”, etc., are just described with reference to specific drawings. The various specific embodiments disclosed in the present invention may be disposed in different manners as shown in the accompanying drawings of the present invention. Therefore, the positional terms used herein should not be limited to the positions shown in the specific embodiments.

The present invention is further described in detail below with reference to the accompanying drawings and specific embodiments.

The present invention discloses a panel light, which includes a front bezel having multiple frames; a light guide inside the front bezel; at least one circuit board fixed on at least one of the multiple frames; and light sources mounted on the at least one circuit board, where a distance between a first light source and the light guide includes a first distance and a distance between a second light source and the light guide includes a second distance, and the first distance is less than the second distance. When the distances between the light sources and the light guide are relatively small, loss of light emitted by the light sources is reduced when the light reaches the light guide, improving light utilization.

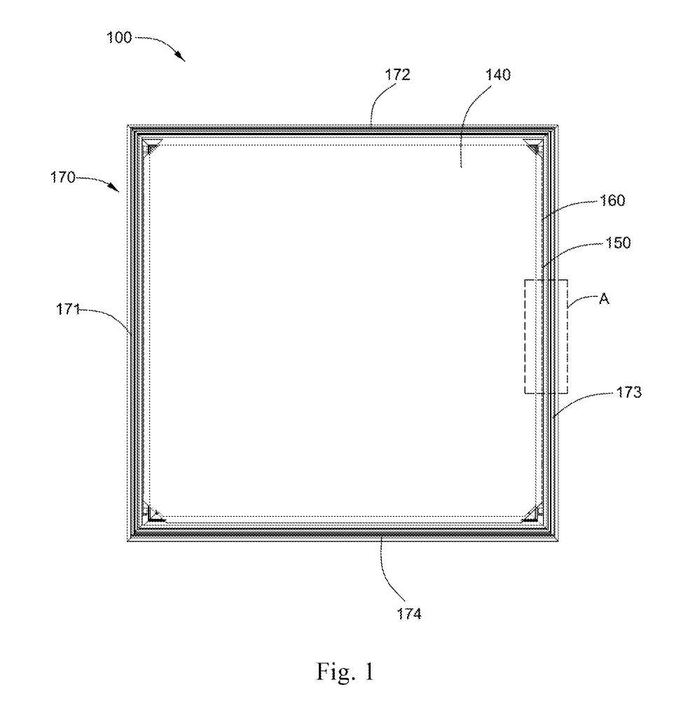

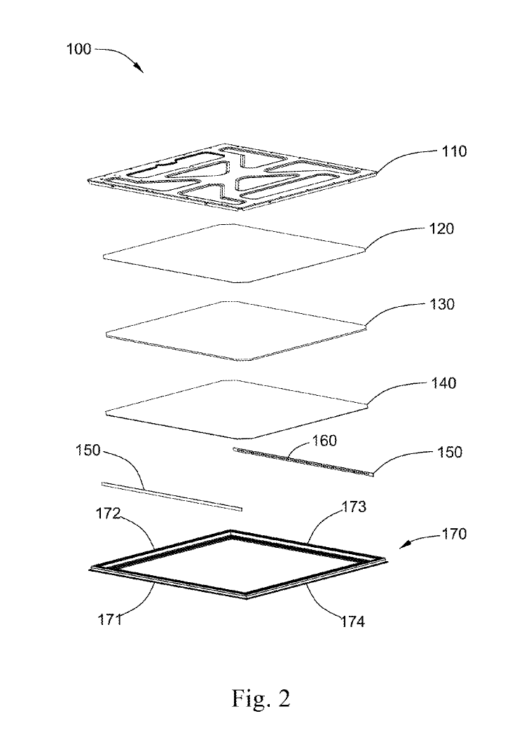

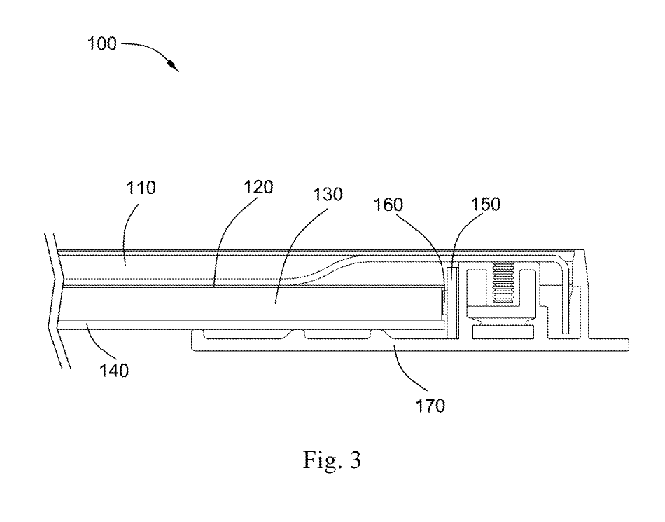

FIG. 1 to FIG. 5 show a panel light 100 according to a specific embodiment of the present invention. Referring to FIG. 1 to FIG. 5, In an embodiment, the panel light 100 includes a light guide 130, two circuit boards 150, light sources 160, and a front bezel 170. The light guide 130 is located inside the front bezel 170. The front bezel 170 includes two convex frames 171 and 173 towards the light guide 130, and two straight frames 172 and 174. The multiple light sources 160 are mounted on the two circuit boards 150 at equal intervals, and the two circuit boards 150 are mounted on the convex frames 171 and 173 respectively. Further, the panel light 100 also includes a back bezel 110, a reflecting film 120, and a diffusion plate 140. Specifically, referring to FIG. 3, the back bezel 110 is mounted on the front bezel 170. The reflecting film 120, the light guide 130, and the diffusion plate 140 are successively tiered between the back bezel 110 and the front bezel 170, where the reflecting film 120 directly contacts the back bezel 110, the diffusion plate 140 directly contacts the front bezel 170, and the light guide 130 and the light sources 160 are in the same plane. Because the light guide 130 has high light transmittance and is provided with multiple print points, the light guide can turn the light sources 160 from a point type into a planar type. The reflecting film 120 can reflect light diffused by the light guide 130 back to the light guide 130, so as to improve luminous efficacy. The diffusion plate 140 can uniformly lead the light out of the light guide 130.

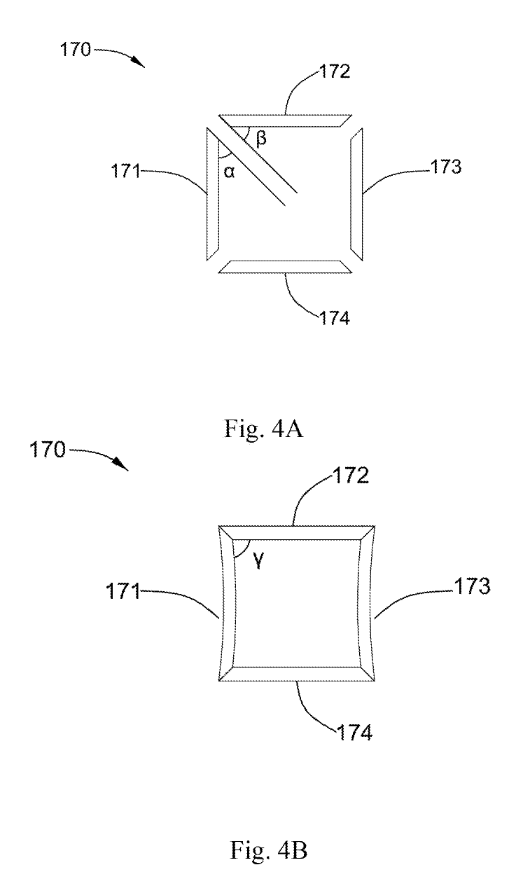

FIG. 4A is a schematic diagram of the front bezel 170 before connection, and FIG. 4B is a schematic diagram of the front bezel 170 after connection. In an embodiment, the front bezel 170 includes four frames 171, 172, 173, and 174. As shown in FIG. 4A, four trapezoidal frames are formed by cutting quadrate frames, where the quadrate frames are formed by firmly pressing a flexible material such as a metal material or thermally conductive plastic. Cutting angles θ of the frames 172 and 174 are 45 degrees, that is, base angles of the trapezoidal frames 172 and 174 formed after cutting are 45 degrees. Cutting angles α of the frames 171 and 173 are less than 45 degrees, and specifically, in a range from 44.5 degrees to 44.7 degrees. That is, base angles of the trapezoidal frames 171 and 173 formed after cutting are less than 45 degrees, and specifically, in a range from 44.5 degrees to 44.7 degrees. Two hypotenuses of the frame 171 are connected to one hypotenuse of the frame 172 and one hypotenuse of the frame 174, the other hypotenuse of the frame 172 and the other hypotenuse of the frame 174 are separately connected to two hypotenuses of the frame 173, to finally form the front bezel 170. FIG. 4B shows the front bezel after connection. As shown in FIG. 4B, by combination of different cutting angles, the included angle γ between any two connected frames is in a range from 89.5 degrees to 89.8 degrees. That is, the frames 171 and 173 are inwardly curved, to form the front bezel 170 having the two convex frames 171 and 173. Therefore, by controlling a cutting angle of each quadrate frame, a front bezel 170 having at least one inwardly curved frame can be obtained. In another embodiment, in order to form a front bezel having at least two convex frames, the following steps may also be performed: A flexible material such as a metal material or thermally conductive plastic is firmly pressed to form four quadrate frames; two of the quadrate frames are remained not to be cut, that is, base angles of the two quadrate frames are 90 degrees; the other two quadrate frames are cut by a cutting angle controlled to be in a range from 89.5 degrees to 89.8 degrees, that is, base angles of trapezoidal frames formed after cutting are in a range from 89.5 degrees to 89.8 degrees; and finally, adjacent hypotenuses of the quadrate frames and the trapezoidal frames are separately connected. By combination of different cutting angles, the included angle between any two connected frames is still in the range from 89.5 degrees to 89.8 degrees, that is, the two trapezoidal frames are inwardly curved.

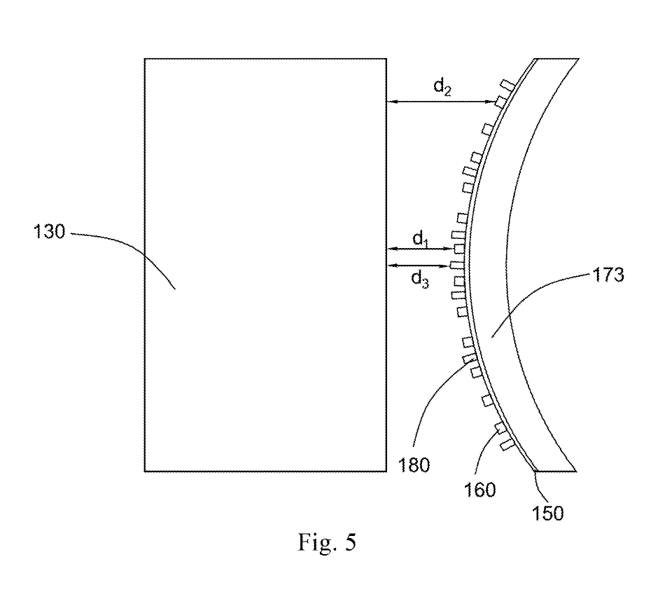

FIG. 5 is a schematic partial enlarged diagram of part A of the panel light 100 shown in FIG. 1. As shown in FIG. 5, because the convex frame 173 is curved towards the light guide 130, the easily deformable circuit board 150 fixed on the frame 173 is also curved towards the light guide 130. As a result, distances between the multiple light sources 160 mounted on the circuit board 150 and the light guide 130 include a first distance d1 and a second distance d2. The first distance d1 is a minimum distance between the light sources 160 and the light guide 130, that is, a light source at the first distance d1 from the light guide 130 is a first light source. The second distance d2 is a maximum distance between the light sources 160 and the light guide 130, that is, a light source at the second distance d2 from the light guide 130 is a second light source. The first distance d1 is less than the second distance d2. Therefore, when the distances between the light sources 160 and the light guide 130 are relatively small, the light sources are avoided from light loss during large-distance propagation, thus improving light utilization. In an embodiment, multiple protecting devices 180 are mounted on the circuit board 150, where a material of the protecting device includes, but not limited to, a hardly deformable material such as a resistance patch. A density of arrangement of the multiple protecting devices 180 in a middle of the circuit board is greater than that in sides of the circuit board. The protecting device 180 is higher than the light source 160. That is, a distance d3 between at least one of the multiple protecting devices 180 and the light guide 130 is less than the first distance d1. Therefore, the protecting device can ensure that the light guide 130 does not directly contact the light source 160 when expanding, so that the light source is avoided from damage. In addition, when the light guide 130 expands and directly contacts the protecting devices 180, the protecting devices 180 on the circuit board 150 fixed on the frame 173 are pressed. Because the frame 173 is made of a flexible material such as a metal material or thermally conductive plastic, the frame 173 has flexibility to a certain degree. Thus, the frame 173 is inwardly curved at an increasingly smaller margin, or even, the frame 173 is straightened, effectively avoiding the light guide 130 from deforming or even breaking due to the press on the protecting devices 180. After the light guide 130 restores to the original shape, the frame 173 also restores to the initial convex shape due to its resilience, so that the light utilization can still be improved.

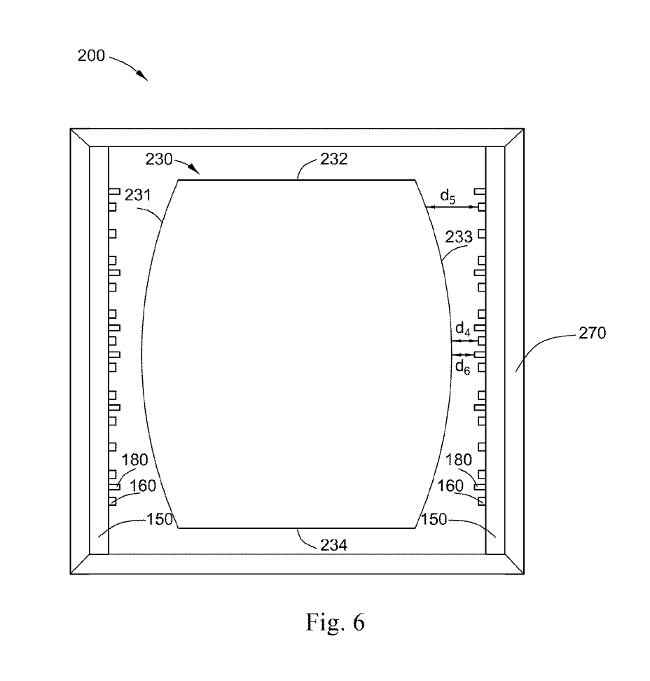

FIG. 6 is a schematic partial diagram of a panel light 200 according to another embodiment of the present invention. Referring to FIG. 6, In an embodiment, the panel light 200 includes a light guide 230, two circuit boards 150, light sources 160, and a front bezel 270. The front bezel 270 has four straight frames. The light guide 230 has two convex sides 231 and 233 towards the front bezel 270, and two straight sides 232 and 234. The two circuit boards 150 are respectively mounted on two frames of the front bezel 270 that are arranged opposite to the sides 231 and 233 of the light guide. Distances between the light sources 160 mounted on the circuit board 150 and the side 231 or 233 of the light guide 230 include a first distance d4 and a second distance d5, where the first distance d4 is less than the second distance d5. The first distance d4 is a minimum distance between the light sources 160 and the side 231 or 233 of the light guide 230, and the second distance d5 is a maximum distance between the light sources 160 and the side 231 or 233 of the light guide 230. Therefore, when the distance between the light source 160 and the light guide 230 is relatively small, the light source is avoided from light loss during large-distance propagation, thus improving light utilization. In another embodiment, multiple protecting devices 180 are mounted on the circuit board 150, and a distance d6 between at least one of the multiple protecting devices 180 and the side 231 or 233 of the light guide 230 is less than the first distance d4.

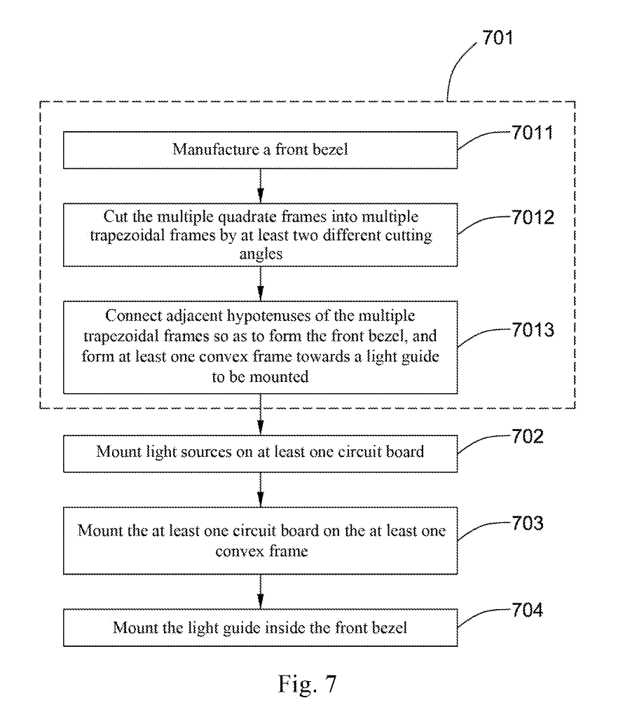

FIG. 7 is a flowchart of a method for manufacturing a panel light according to a specific embodiment of the present invention. The method for manufacturing a typical panel light according to a specific embodiment of the present invention includes the following steps:

As shown in FIG. 7, in step 701, a front bezel is manufactured, which includes sub-steps 7011 to 7013:

In sub-step 7011, multiple quadrate frames are made. In an embodiment, a flexible material such as a metal material or thermally conductive plastic is firmly pressed to form four quadrate frames.

In sub-step 7012, the multiple quadrate frames are cut into multiple trapezoidal frames by at least two different cutting angles. In an embodiment, the four quadrate frames are cut into four trapezoidal frames by two different cutting angles, where base angles of two of the four trapezoidal frames are 45 degrees; and base angles of the other two trapezoidal frames are less than 45 degrees, and specially, in a range from 44.5 degrees to 44.7 degrees.

In sub-step 7013, adjacent hypotenuses of the multiple trapezoidal frames are connected so as to form the front bezel, and form at least one convex frame towards a light guide to be mounted. In an embodiment, adjacent hypotenuses of the four trapezoidal frames obtained after cutting are connected by means of, for example, welding, corner stamping, or the like, so as to form the front bezel. By combination of angles, the two trapezoidal frames of which the base angles are less than 45 degrees are curved towards the light guide to be mounted. In an alternative embodiment, during connection, an external force may be applied between the two trapezoidal frames of which the base angles are less than 45 degrees. For example, the two frames are fastened together by connecting a flexible device.

In step 702, light sources are mounted on at least one circuit board. In an embodiment, the light sources are mounted on the two circuit boards at equal intervals. In an alternative embodiment, multiple protecting devices are mounted on the two circuit boards, where a material of the protecting device includes, but not limited to, a hardly deformable material such as a resistance patch. A density of arrangement of the multiple protecting devices in a middle of the circuit board is greater than that in sides of the circuit board.

In step 703, the at least one circuit board is mounted on the at least one convex frame.

In step 704, the light guide is mounted inside the front bezel.

In an alternative embodiment, a back bezel is mounted on the front bezel.

The panel light of the present invention not only can protect the light sources and light guide against damage, but also can relatively reduce distances between the light sources and the light guide, thus improving light utilization.

Although steps of a method for manufacturing a panel light according to a specific embodiment of the present invention are shown as functional blocks, the separation of the sequence of the functional blocks shown in FIG. 7 and the actions between the functional blocks is not intended to be restrictive. For example, the various functional blocks may be executed in a different order, and the actions associated with one functional block may be combined with one or more other functional blocks or may be subdivided into a plurality of functional blocks.

While the present invention has been described in detail with reference to specific embodiments thereof, it will be understood by those skilled in the art that many modifications and variations can be made in the present invention. It is, therefore, to be understood that the appended claims are intended to cover all such modifications and variations insofar as they are within the true spirit and scope of the invention.

What we claim is:

1. A panel light, comprising:
a front bezel having multiple frames;
at least one circuit board fixed on at least one of the multiple frames;
light sources mounted on the at least one circuit board; and
a light guide inside the front bezel;

2. The panel light of claim 1, wherein the first distance is a minimum distance between the first light source and the light guide, at least one protecting device is mounted on the at least one circuit board, and a distance between the at least one protecting device and the light guide is less than the first distance.

3. The panel light of claim 2, wherein the at least one protecting device comprises multiple protecting devices and a density of arrangement of the multiple protecting devices in a middle of the circuit board is greater than that in sides of the circuit board.

4. The panel light of claim 1, wherein the multiple frames comprise at least one convex frame towards the light guide, and the at least one circuit board is mounted on the at least one convex frame, and the first distance and the second distance are between the light sources on the at least one circuit board and the light guide.

5. The panel light of claim 4, wherein the front bezel comprises four trapezoidal frames, and a base angle of at least one of the four trapezoidal frames is less than 45 degrees.

6. The panel light of claim 5, wherein the base angle of the at least one of the four trapezoidal frame is in a range from 44.5 degrees to 44.7 degrees.

7. The panel light of claim 1, further comprising a back bezel mounted on the front bezel.

8. A method for manufacturing a panel light, comprising:
manufacturing a front bezel comprising:
making multiple quadrate frames;
cutting the multiple quadrate frames into multiple trapezoidal frames by at least two different cutting angles; and
connecting adjacent hypotenuses of the multiple trapezoidal frames so as to form the front bezel, and form at least one convex frame towards a light guide to be mounted;
mounting light sources on at least one circuit board;
mounting the at least one circuit board on the at least one convex frame; and
mounting the light guide inside the front bezel.

9. The method for manufacturing the panel light of claim 8, wherein the front bezel comprises four trapezoidal frames, and a base angle of at least one of the four trapezoidal frames is less than 45 degrees.

10. The method for manufacturing the panel light of claim 8, comprising:
mounting at least one protecting device on the at least one circuit board, and a distance between the at least one protecting device and the light guide is less than a minimum distance between the light sources on the at least one circuit board and the light guide.
